(19) United States
(12) Patent Application Publication
(10) Pub. No.: US 2014/0164664 A1
(43) Pub. Date: Jun. 12, 2014

(54) ORTHOGONAL LAYOUT GENERATION

(71) Applicants: Qiying Gong, Shanghai (CN); Hongxiang Qiu, Shanghai (CN); Bruce Alan Scovill, Denver, CO (US); Bo Su, Shanghai (CN)

(72) Inventors: Qiying Gong, Shanghai (CN); Hongxiang Qiu, Shanghai (CN); Bruce Alan Scovill, Denver, CO (US); Bo Su, Shanghai (CN)

(73) Assignee: GENERAL ELECTRIC COMPANY, Schenectady, NY (US)

(21) Appl. No.: 13/320,210

(22) PCT Filed: Aug. 23, 2011
(86) PCT No.: PCT/CN11/01403

§ 371 Date: Nov. 11, 2011

(51) Int. Cl. G06F 13/40

(52) U.S. Cl. CPC G06F 13/40
USPC 710/305

(57) ABSTRACT

An orthogonal layout generation method can include receiving, in a computer system, data related to a plurality of devices for a schematic layout, generating, in the computer system, a node for each of the plurality of devices, hereby generating a plurality of nodes, generating, in the computer system, a link for each of the plurality of nodes, thereby generating a plurality of links, orthogonalizing, in the computer system, the plurality of nodes, initializing, in the computer system, a route for each of the plurality of links, thereby generating a plurality of routes, orthogonalizing, in the computer system, the routes and selecting, in the computer system, a direction for each of the plurality of routes.

### CROSS REFERENCE TO RELATED APPLICATIONS

The present application is a National Stage Application of PCT Application No. PCT/CN2011/001403 filed on Aug. 23, 2011, and which is hereby incorporated by reference.

### BACKGROUND OF THE INVENTION

The subject matter disclosed herein relates to layout algorithms and more particularly to systems and methods for orthogonal layout generation that decreases the rate of cross-over lines in layouts.

Graphical layouts are typically implemented to easily view actual physical layouts. For example, in power distribution, a distribution management system (DMS) controls power on a power grid. DMS operators maintain a geospatial graphical layout of actual physical components of the power grid such as power transformers, substations, capacitors and the like. The layout is ideally a de-cluttered and spatially tightened view of the actual physical components on the power grid. The layout aids the DMS operators to make power switches, dispatch crews and perform other duties related to the power grid. The actual physical components on the power grid are subject to change given new construction, re-routing of power cables and the like. The layout of a power grid as well as changes on the power grid are typically kept in a geographic information system (GIS). In order to properly perform the DMS operations, the data in the DMS and GIS are kept in sync. As changes occur in both the GIS and the DMS, the layout can be become cluttered, with overlapping lines, which can make proper DMS operation difficult. Changes to the DMS power grid layout are typically manually performed. Algorithms can be implemented to automatically generate new layouts based on updated GIS data. However, conventional algorithms do not consider spatial relationship of actual physical components on the power grid. To obtain vertical and horizontal line routing as much as possible, the algorithms combine some connected lines to one line and lots of nodes were removed from the original network. Objects in a generated layout are less than the original one and the spatial relationship of objects are changed, which gives a layout that is inconsistent with the actual physical components, which is not acceptable for DMS operation.

### BRIEF DESCRIPTION OF THE INVENTION

According to one aspect of the invention, an orthogonal layout generation method is described. The method can include receiving, in a computer system, data related to a plurality of devices for a schematic layout, generating, in the computer system, a node for each of the plurality of devices, thereby generating a plurality of nodes, generating, in the computer system, a link for each of the plurality of nodes, thereby generating a plurality of links, orthogonalizing, in the computer system, the plurality of nodes, initializing, in the computer system, a route for each of the plurality of links, thereby generating a plurality of routes, orthogonalizing, in the computer system, the routes and selecting, in the computer system, a direction for each of the plurality of routes.

According to another aspect of the invention, a computer program product including a non-transitory computer readable medium storing instructions for causing a computer to implement an orthogonal layout generation method is described. The method can include receiving data related to a plurality of devices for a schematic layout, generating a node for each of the plurality of devices, thereby generating a plurality of nodes, generating a link for each of the plurality of nodes, thereby generating a plurality of links, orthogonalizing the plurality of nodes, initializing a route for each of the plurality of links, thereby generating a plurality of routes, orthogonalizing the routes and selecting a direction for each of the plurality of routes.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a flow chart of a method for generating an orthogonal layout in accordance with exemplary embodiments.

FIG. 2 illustrates an example of a quadrant generated in accordance with exemplary embodiments.

FIG. 3 illustrates an example of a quadrant that includes slots.

FIG. 4 illustrates an example of a quadrant, which diagrammatically illustrates a slots calculation.

FIG. 5 illustrates an example of a logical model having orthogonalized routes in accordance with exemplary embodiments.

FIG. 6 illustrates an example of an intermediate logical model in accordance with exemplary embodiments.

FIG. 7 illustrates an example of a logical model before orthogonalization and a logical model after orthogonalization in accordance with exemplary embodiments.

FIG. 8 illustrates a logical model before staggering and a logical model after staggering in accordance with exemplary embodiments.

FIG. 9 illustrates a logical model illustrating actual connectivity of the logical model before staggering in FIG. 8.

FIG. 10 illustrates an example of a logical model that defines minimum spacing between nodes.

FIG. 11 illustrates a logical model that includes cross over and a logical model that is free of cross over.

FIG. 12 illustrates logical models that include cross overs and a logical model that is free of cross overs.

FIG. 13 illustrates an example quadrant that illustrates routes in one quadrant.

FIG. 14 illustrates a logical model for selection of a route between nodes.

FIG. 15 illustrates a logical model for an alternate selection of a route between nodes.

FIG. 16 illustrates an exemplary embodiment of a system for orthogonal layout generation.

The detailed description explains embodiments of the invention, together with advantages and features, by way of example with reference to the drawings.

### DETAILED DESCRIPTION OF THE INVENTION

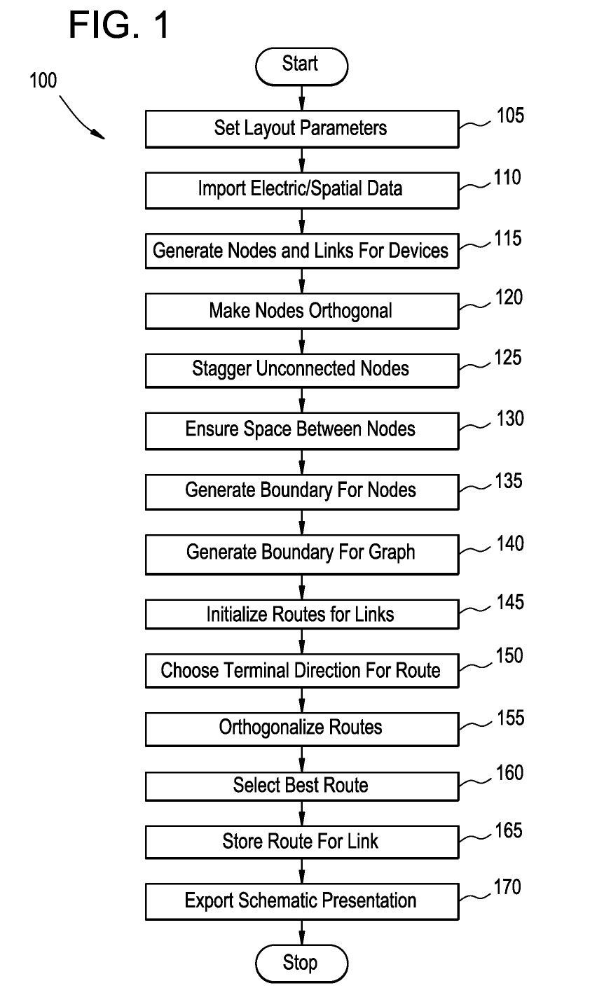

FIG. 1 illustrates a flow chart of a method 100 for generating an orthogonal layout in accordance with exemplary embodiments. For illustrative purposes, an example of a power grid and a DMS power grid layout are discussed with respect to the systems and methods described herein. It will be appreciated that the exemplary systems and methods can be implemented to generate layouts in other applications other than DMS power grids. The systems and methods described herein generate orthogonal layout using both spatial location and topological information for physical components in a power grid. The orthogonal layout is able to maintain the consistency of relative spatial location of devices and suitable for use in electrical utilities. Several adjustments to the layout then provide functionality including, but not limited to: making the layout in as straight lines as much as possible; providing capabilities that route between points as directly as possible; implementing vertical and horizontal line routing as much as possible; and reducing cross-over and overlay between point and point, point and line, line and line. The rate of cross over or overlay is the significantly reduced (e.g., less than 5%). As further described herein, an orthogonal layout generation algorithm can be implemented in a suitable computer system to perform the method 100.

Each of the blocks of the method 100 are now summarized and then described further herein. It will be appreciated that the various blocks described herein can be performed at different times and not necessarily serially. At block 105, the computer system sets layout parameters. At block 110, the computer system imports electric and spatial data related to the physical components of the power grid. At block 115, the computer system generates nodes and links for the devices in the power grid. At block 120, the computer system makes the nodes orthogonal. At block 125, the computer system staggers unconnected nodes. At block 130, the computer system ensures that there are spaces between the nodes. At block 135, the computer system generates boundaries for the nodes. At block 140, the computer system then generates a boundary for the overall graph defining the power grid layout. At block 145, the computer system initializes routes for links between the nodes. At block 150, the computer system chooses a terminal direction for the routes. At block 155, the computer system makes the routes orthogonal. At block 160, the computer system selects a best route for the nodes. At block 165, the computer system stores the route for a link. At block 170, the computer system exports the schematic presentation for the power grid, which can then be implemented for a DMS as described herein.

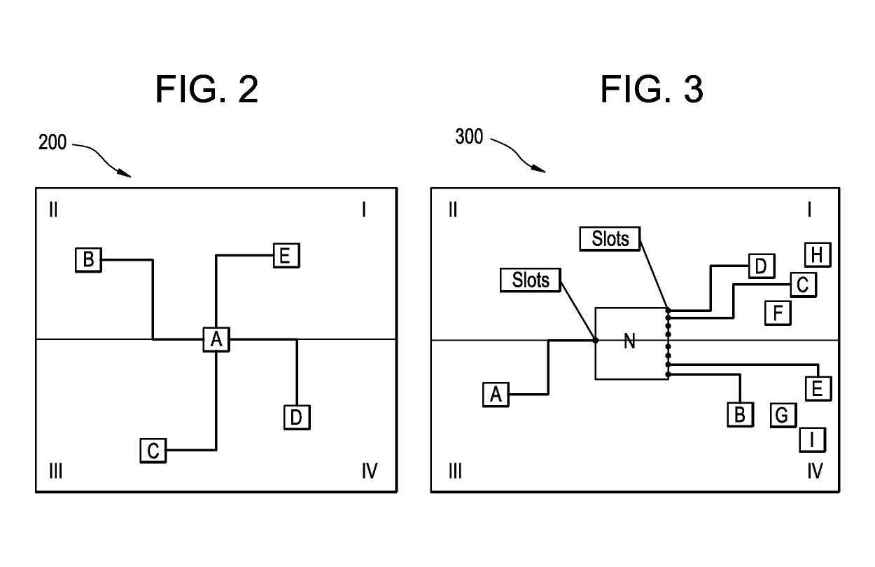

In exemplary embodiments, the systems and methods described herein implement quadrant concepts for layout generation. A quadrant definition is the same definition as the definition in a coordinate system. In exemplary embodiments, to generate enhanced orthogonal routes for a link, for example, the systems and methods described herein classify all nodes that connect with current node (i.e., an original point of coordinate system) in term of four quadrants. A quadrant is created dynamically for every node. FIG. 2 illustrates an example of a quadrant 200 generated in accordance with exemplary embodiments. An example of a convention described herein is as follows: If node A is a current node, then the node E distributes in the quadrant I of node A and the node D is in the quadrant IV. If “D” is a current node and the node A is in the quadrant II of node D. It will be appreciated that the quadrant 200 of nodes is a dynamic attribute. Defining the quadrant 200 of nodes therefore aids in the several blocks described with respect to FIG. 1. Another convention described herein is slots. A slot represents a position of a bounding box of a node where a line can be connected. The systems and methods described herein generate a number of slots for each side of node based on connected links and respective bounding box size. The slots connect routes between nodes. Meanwhile, in order to avoid cross-overs, as further described herein, the exemplary systems and methods select slots for route based on the quadrant of the connected node. FIG. 3 illustrates an example of a quadrant 300 that includes slots. As illustrated, the slots are on either side of the magnified node N. There is one connected node A in quadrant III, and one corresponding slot on node N. But there are eight connected nodes B, C, D, E, F, G, H, I on the other side of node N. As such, eight corresponding slots are generated.

In exemplary embodiments, an example calculation of the coordinates of slots is shown in the following equation:

Equation for left/right:

Y=StartY+(Index/(Number+1.0))*Length

X=StartX

Equation for up/down:

Y=StartY;

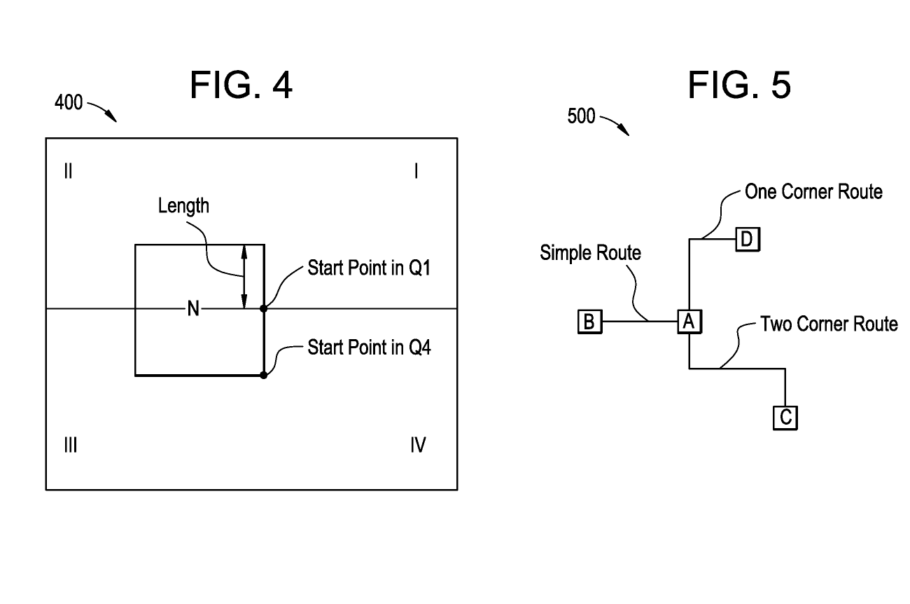

X=StartX+(Index/(Number+1.0))*Length

Where (for quadrant I):
Length: the length of each side of bounding box that belongs in quadrant I;
Number: the number that nodes can be connected to this section, for example, the node N in FIG. 3 can be connected to four nodes in quadrant I;
StartX, StartY: coordinate of the first slot on the sides of bounding box of current node distributed in each quadrant, as shown in FIG. 4, which diagrammatically illustrates a quadrant 400 diagrammatically showing a slots calculation;
Index: index for specific slot from 1 to N.

Another convention described herein is orthogonalized routes. The exemplary systems and methods described herein generate routes for each link and ensure the route is orthogonal. As described herein, orthogonal means that the lines are vertical or horizontal, as illustrated in FIG. 5, which illustrates an example of a logical model having orthogonalized routes in accordance with exemplary embodiments. In exemplary embodiments, there are various methods to generate orthogonal routes. For example, a simple route that only contains two terminal points is generated. In another example, one corner route is generated. In another example, the last one is to generate two corner routes are generated. In exemplary embodiments, the method 100 orthogonal routes are generated in the following priority: 1) two terminal points; 2) one corner route; and 3) two corner routes. It is desirable to have this priority to reduce clutter and potential cross-overs in the final layout.

Referring again to FIG. 1, the various blocks of the method 100 are now described. At block 105, the computer system sets the layout parameters. In exemplary embodiments, the method 100 can receive a configuration file, in which parameters for the various blocks in the method 100 can be input and adjusted. The configuration file can have any desirable format and can depend on the programming language implemented in the method 100. At block 110, the computer system imports the electric/spatial data. For example, a data source of the electric data can be in an extensible mark-up language (XML) format or a Common Information Model File (CIM) format. Regardless of the file format, the method 100 extracts connectivity information related to the physical components of the power grid and generates a respective node for each physical component in the power grid. For the spatial data, the computer system can receive geographic information system (GIS) data, which can be in a graph modeling language (GML) file format. Regardless of the file format, the method 100 extracts the coordinate information from the spatial data for translating the data into a format for the exemplary quadrant as described herein. The coordinate information can be assigned a unique identification (ID) based on electric data.

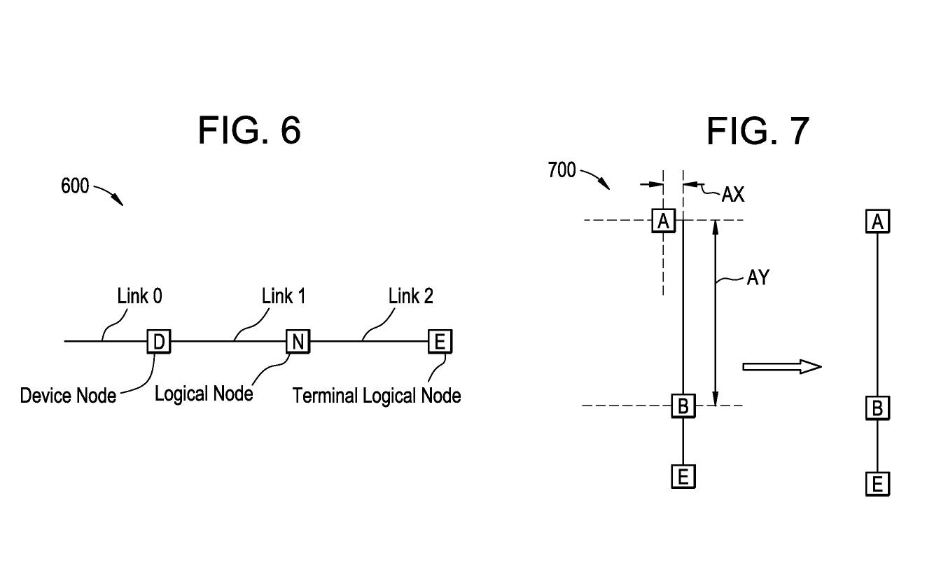

At block 115, the computer system generates nodes and links for the devices (i.e., the physical components on the power grid). In exemplary embodiments, the method 100 generates nodes for point devices, generates nodes and corresponding coordinates for internal connectivity (logical) points, and generates nodes and corresponding coordinates for terminal (end) points. Since the point devices correspond to actual physical components and have its own geo-coordinates, the method 100 generates geo-coordinates directly based on its own geo-coordinates. The internal connectivity points are logical points that don't have corresponding physical components from GIS data. The points can be connecting points between line segments in the intermediate layout. As such, the method 100 generates geo-coordinates for the nodes based the connected line segments and only processes the nodes that connect two or more line segments at this stage. The end points locate the end of a line segment. FIG. 6 illustrates an example of an intermediate logical model 600 generated at block 115. The geo-coordinates of node “E” is generated based on link 2 and node N, a logical node, because the link 2 has the geo-coordinates at the location of node E, and end node. As such, the method 100 can compare and generate the geo-coordinates of node E.

The method 100 then generates logical links for all real line segments and virtual line segments for those links to maintain topological information. Since the nodes are generated first, the method 100 can generate logical links for line segments based on all nodes. In exemplary embodiments, each line segment (i.e., link) connects two nodes in the data model. At this stage in the method 100, actual geographical information is not included and thus the node and link layout at this state does not represent the final orthogonal route. In exemplary embodiments, each node includes several attributes, including, but not limited to: 1) ID; 2) geo-coordinates and 3) connectivity information between nodes and links, which can be stored with each node when the final layout is generated. As such, all nodes and links correspond to the original model data through this stage, while all nodes have coordinates.

At block 120, the computer system orthogonalizes the nodes, which adjust routes between nodes to be as direct as possible. FIG. 7 illustrates an example of a logical model 700 before orthogonalization and a logical model 705 after orthogonalization in accordance with exemplary embodiments. In the example in FIG. 7, a Δx and a Δy are defined. The Δx shows an offset between the x coordinates of node A and node B and Δy shows an offset between the y coordinates of node A and node B. Block 120 makes the routes between nodes as direct as possible. As described herein, the term orthogonal means that the lines are vertical or horizontal. In FIG. 7, the Δx shows a mismatch between the x coordinates of node A and node B in the logical model 700. As such, the method 100 moves node A so that node A can have same x coordinate value with node “B” as shown in the logical model 705. The method 100 can carry out similar orthogonal adjustments in the y direction.

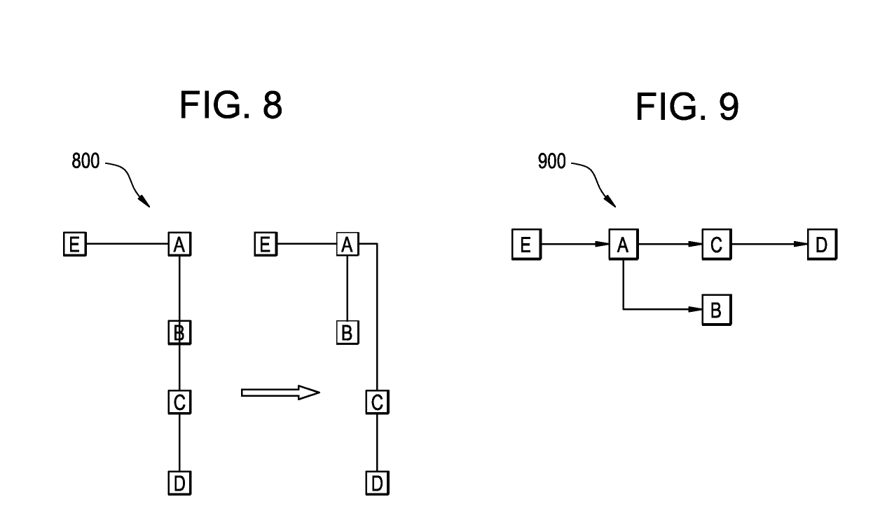

At block 125, the computer system staggers unconnected nodes to prevent cross-over. FIG. 8 illustrates a logical model 800 before staggering and a logical model after staggering in accordance with exemplary embodiments. The logical model 800 appears that all nodes A, B, C, D, E are connected end to end. FIG. 9 illustrates a logical model 900 illustrating actual connectivity of nodes A, B, C, D, E. As such, the node B doesn't connect to node C as illustrated in the logical model 800, but they have the same x coordinate value. In exemplary embodiments, the method 100 moves some nodes according to the y coordinate values, to avoid these crossovers and overlay. In exemplary embodiments, to stagger unconnected nodes, the computer system can group all nodes, which have the same x coordinate values, according to connectivity information. Then the computer system sorts the connected nodes ascending by y-axis for each group and then moves the unconnected nodes by Δx. The result as staggering according the method 100 s shown in the logical model 705, which illustrates the actual connectivity between node A and node B according to the logical model 900.

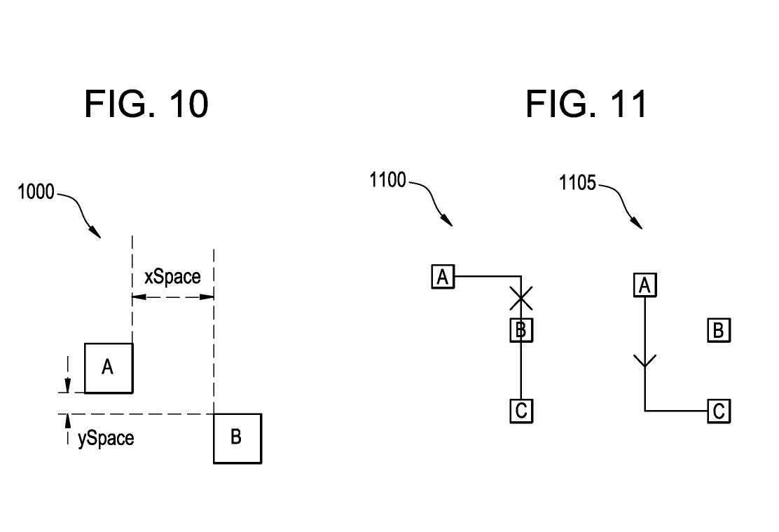

At block 130, the computer system ensures that there is space between the nodes by setting and adjusting space between nodes. FIG. 10 illustrates an example of a logical model 1000 that defines minimum spacing between nodes. In exemplary embodiments, the method 100 sets a minimum distance xSpace, ySpace in the x-axis and y-axis direction, respectively, between any two nodes, in the example, node A and node B. If there is any distance which is smaller than xSpace for the x-axis direction or ySpace for the y-axis direction, the method 100 moves the node that has the larger x or y value.

At block 135, the computer system generates a boundary for the nodes. Each node is a point and contains its geo-coordinates, so the nodes don't have an area or bounding box. But in GIS data, the symbol of a point covers an area in the location, so in order to display the symbol of devices without overlay in a graph, the systems and methods described herein generate bounding boxes for each node based on parameters of symbol size. The nodes illustrated in FIGS. 2-10 and subsequent figures herein illustrate bounding boxes.

At block 140, the computer system generates a boundary for the entire graph of the layout. The purpose of the graph boundary is for defining the final schematics diagram. Once all nodes are positioned as described herein, the boundary of the graph is defined.

At block 145, the computer system initializes routes for links. Block 145 creates the data for generating routes of link, including read nodes and link data, read sorted nodes data and create quadrant for relative nodes that connect each other. Referring again to FIG. 2, the quadrant 200 is dynamic for every node. As stated herein, if node A is a current node, then the node E belongs to the quadrant I for node A and the node D belongs to the quadrant IV for node A, but if node D is a current node, the node A belongs to the quadrant II. The quadrant 200 of nodes is a dynamic attribute and the reference frame is based on matches among the nodes. Initializing routes for the links is necessary in order to generate the links. In exemplary embodiments, the routes are generated from the links, in which the starting point is the highest node in the y direction. The computer system then generates all routes for links from the highest point to the lowest point.

At block 150, the computer system chooses a terminal direction for the route. In exemplary embodiments, the computer system generates slots for each side of a node based on connected links and its bounding box size. The slots connect the route between nodes. Because the slot number is limited, the connected routes of each side of node are not more than its slot number. Further more, the computer system selects slots for the route based on the quadrant of the connected node. Referring again to FIG. 3, the slots are on either side of the magnified node N. There is one connected node A in quadrant III, and one corresponding slot on node N. But there are eight connected nodes B, C, D, E, F, G, H, I on the other side of node N. As such, eight corresponding slots are generated.

At block 155, the computer system orthogonalizes the routes. The computer system generates the route for each link and ensures that the route is orthogonal. At block 160, the computer system chooses the best route. Blocks 155, 160 are performed in conjunction with one another. As described herein, there are several steps to choose the best route for a link. In addition, there can be priorities set when the method 100 selects the best route. Referring again to FIG. 5, in exemplary embodiments, the simple route is the highest priority, the one corner route is the second priority and the two corners route is the lowest priority.

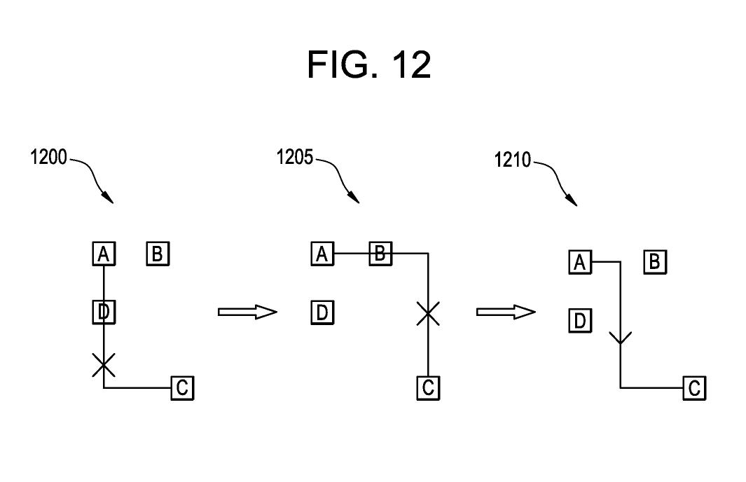

In exemplary embodiments, the method checks cross over between nodes and routes and stores the information in memory when the route is generated, if the route crosses over with nodes, the route is rejected. In exemplary embodiments, the method 100 generates all possible routes for a link and selects the best one (i.e., free of cross overs). FIG. 11 illustrates a logical model 1100 that includes cross over and a logical model 1105 that is free of cross over. In exemplary embodiments, the route between node A and node C crosses over node B. As such, the method 100 rejects the logical model 1100. In contrast, the logical model 1105 is free of cross overs, so the method 100 accepts and saves the logical model 1105. The example in FIG. 11 illustrates a one corner route. If all possible one corner routes are rejected because of cross over with nodes, the method 100 generates a two corners route for the link. FIG. 12 illustrates logical models 1200, 1205 that include cross over and a logical model 1210 that is free of cross over. The node A connects to node C, so in the logical model 1200, the route crosses the node D, and in the logical model 1205, the route crosses the node B. Since the two possible one route corners of the logical models 1200, 1205, are rejected, the method 100 generates a two corners route as in the logical model 1210, which is free of cross overs.

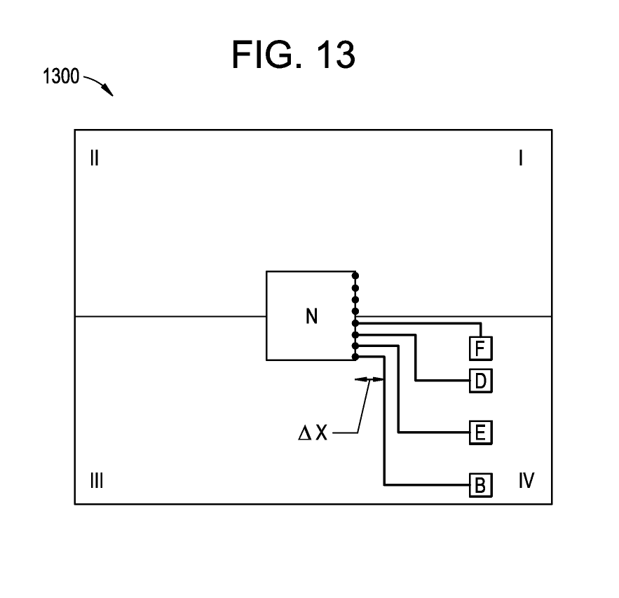

FIG. 13 illustrates an example quadrant 130 that illustrates routes in one quadrant. In exemplary embodiments, to orthongonalize the routes of two corners, as shown in FIG. 13, the systems and methods described herein sort all nodes that belong to quadrant IV by the y axis, and then choose the appropriate slot in node “N”. In the example, an offset ΔX is selected between routes to avoid crossovers between different routes in same quadrant.

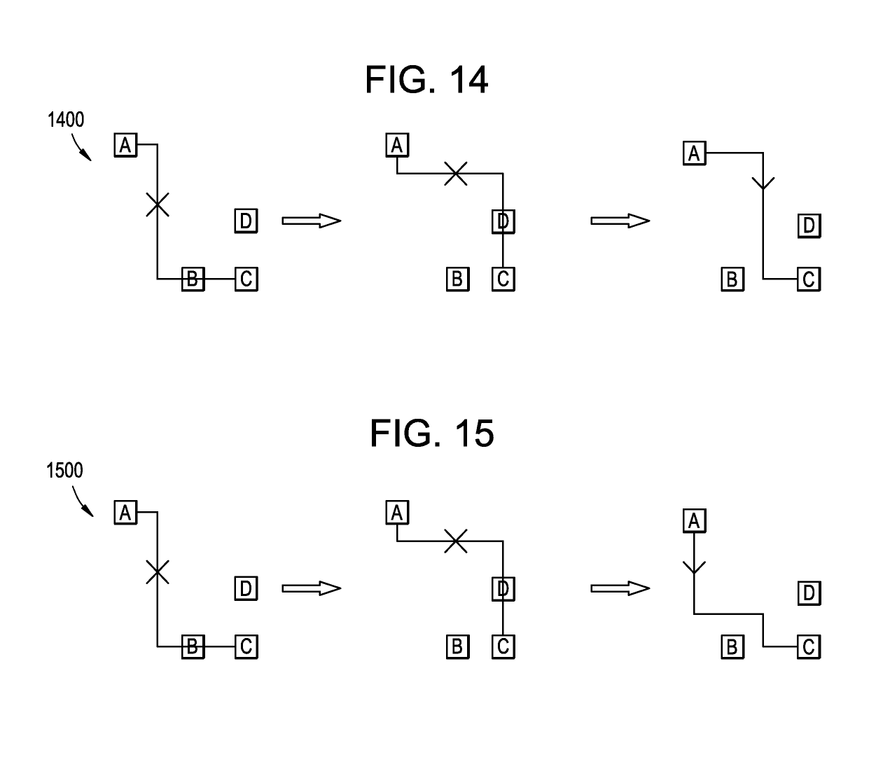

For two corners routes, there can be issues for the selection of the corner position between the connected nodes. Different corner positions may have different results, although they have same corners. The manner in which the position of the corner is selected depends on the current position on the nodes in question. FIG. 14 illustrates a logical model 1400 for selection of a route between node A and node and node C. FIG. 15 illustrates a logical model 1500 for an alternate selection of a route between node A and node C. The selection of the route can be based on prevention of cross over and overlay with other possible nodes in the power grid.

At block 165, the computer system stores the route geometry for the links. The route geometry is implemented to display schematics on the final layout. At block 170, the computer system exports the schematic representation to a suitable storage medium and ultimately a viewer. This exportation enables users to export the layout result. As described herein, the export file format can be a GML file, SVG file, or any other suitable format. For example, the computer system can support conversion of the SVG file into other format files such as but not limited to: 1) Portable Document Format (PDF); 2) Joint Photographic Experts Group (JPEG); and 3) Tagged Image File Format (TIFF).

The method 100 described above has been described as being implemented in a computer system.

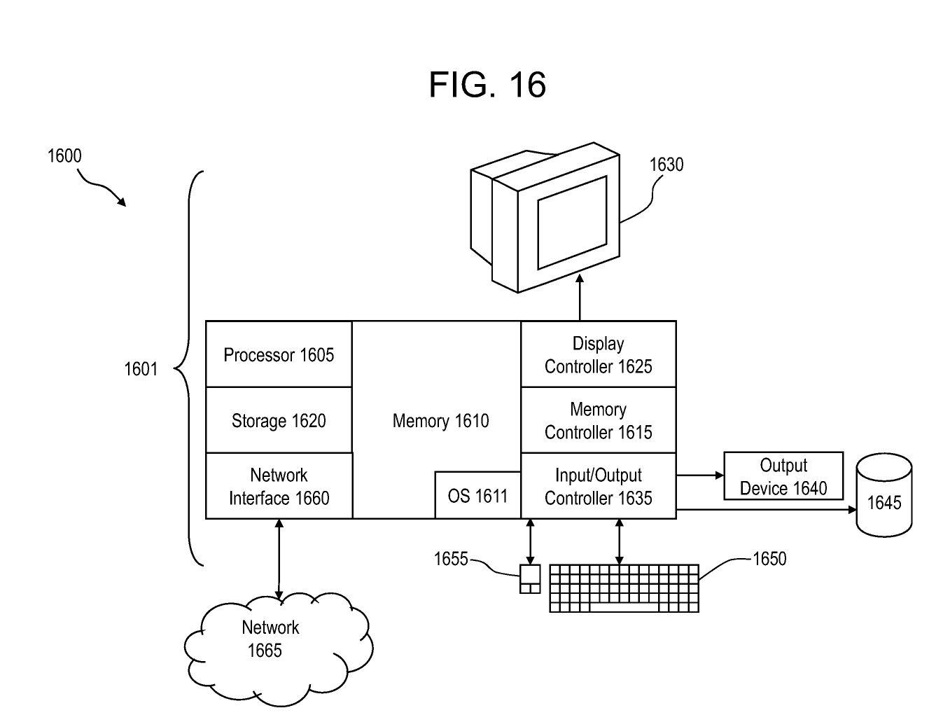

FIG. 16 illustrates an exemplary embodiment of a system 1600 for orthogonal layout generation. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 1600 therefore includes general-purpose computer 1601.

In exemplary embodiments, in terms of hardware architecture, as shown in FIG. 16, the computer 1601 includes a processor 1605, memory 1610 coupled to a memory controller 1615, and one or more input and/or output (I/O) devices 1640, 1645 (or peripherals) that are communicatively coupled via a local input/output controller 1635. The input/output controller 1635 can be, but is not limited to, one or more buses or other wired or wireless connections, as is known in the art. The input/output controller 1635 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1605 is a hardware device for executing software, particularly that stored in memory 1610. The processor 1605 can be any custom made or commercially available processor, a central processing unit (CPU), an auxiliary processor among several processors associated with the computer 1601, a semiconductor based microprocessor (in the form of a microchip or chip set), a macroprocessor, or generally any device for executing software instructions.

The memory 1610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 1610 may incorporate electronic, magnetic, optical, and/or other types of storage media. Note that the memory 1610 can have a distributed architecture, where various components are situated remote from one another, but can be accessed by the processor 1605.

The software in memory 1610 may include one or more separate programs, each of which comprises an ordered listing of executable instructions for implementing logical functions. In the example of FIG. 16, the software in the memory 1610 includes the orthogonal layout generation methods described herein in accordance with exemplary embodiments and a suitable operating system (OS) 1611. The OS 1611 essentially controls the execution of other computer programs, such the orthogonal layout generation systems and methods as described herein, and provides scheduling, input-output control, file and data management, memory management, and communication control and related services.

The orthogonal layout generation methods described herein may be in the form of a source program, executable program (object code), script, or any other entity comprising a set of instructions to be performed. When a source program, then the program needs to be translated via a compiler, assembler, interpreter, or the like, which may or may not be included within the memory 1610, so as to operate properly in connection with the OS 1611. Furthermore, the orthogonal layout generation methods can be written as an object oriented programming language, which has classes of data and methods, or a procedure programming language, which has routines, subroutines, and/or functions.

In exemplary embodiments, a conventional keyboard 1650 and mouse 1655 can be coupled to the input/output controller 1635. Other output devices such as the I/O devices 1640, 1645 may include input devices, for example but not limited to a printer, a scanner, microphone, and the like. Finally, the I/O devices 1640, 1645 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 1600 can further include a display controller 1625 coupled to a display 1630. In exemplary embodiments, the system 1600 can further include a network interface 1660 for coupling to a network 1665. The network 1665 can be an IP-based network for communication between the computer 1601 and any external server, client and the like via a broadband connection. The network 1665 transmits and receives data between the computer 1601 and external systems. In exemplary embodiments, network 1665 can be a managed IP network administered by a service provider. The network 1665 may be implemented in a wireless fashion, e.g., using wireless protocols and technologies, such as WiFi, WiMax, etc. The network 1665 can also be a packet-switched network such as a local area network, wide area network, metropolitan area network, Internet network, or other similar type of network environment. The network 1665 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 1601 is a PC, workstation, intelligent device or the like, the software in the memory 1610 may further include a basic input output system (BIOS) (omitted for simplicity). The BIOS is a set of essential software routines that initialize and test hardware at startup, start the OS 1611, and support the transfer of data among the hardware devices. The BIOS is stored in ROM so that the BIOS can be executed when the computer 1601 is activated.

When the computer 1601 is in operation, the processor 1605 is configured to execute software stored within the memory 1610, to communicate data to and from the memory 1610, and to generally control operations of the computer 1601 pursuant to the software. The orthogonal layout generation methods described herein and the OS 1611, in whole or in part, but typically the latter, are read by the processor 1605, perhaps buffered within the processor 1605, and then executed.

When the systems and methods described herein are implemented in software, as is shown in FIG. 16, the methods can be stored on any computer readable medium, such as storage 1620, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the orthogonal layout generation methods are implemented in hardware, the orthogonal layout generation methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include but are not limited to: 1) retention of all original objects (e.g., from GIS data) and geographical relationship among the objects in the generated layout; 2) maintenance of consistency of relative spatial location of devices (e.g., physical components of the power grid); 3) routing vertical and horizontal lines as much as possible; 4) routing between points as directly as possible; 5) reducing cross-over and layover to less than a 5% cross over rate.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An orthogonal layout generation method, comprising:
receiving, in a computer system, data related to a plurality of devices for a schematic layout;
generating, in the computer system, a node for each of the plurality of devices, thereby generating a plurality of nodes;
generating, in the computer system, a link for each of the plurality of nodes, thereby generating a plurality of links;
orthogonalizing, in the computer system, the plurality of nodes;
initializing, in the computer system, a route for each of the plurality of links, thereby generating a plurality of routes;
orthogonalizing, in the computer system, the plurality of routes; and
selecting, in the computer system, a direction for each of the plurality of routes.

2. The method as claimed in claim 1 wherein each of the plurality of nodes can be at least one of a node for a point device, a node for an internal connectivity point and a node for an end point.

3. The method as claimed in claim 1 wherein orthogonalizing the plurality of nodes reduces offsets for the plurality of routes.

4. The method as claimed in claim 1 further comprising moving, in the computer system, nodes of the plurality of nodes that are unconnected by links to reduce at least one cross-overs and overlays between the plurality of nodes and the plurality of routes.

5. The method as claimed in claim 1 further comprising adjusting, in the computer system, spaces between each of the plurality of nodes and other nodes of the plurality of nodes to increase the spaces above a predetermined distance.

6. The method as claimed in claim 1 further comprising generating, in the computer system, a boundary for each of the plurality of nodes.

7. The method as claimed in claim 6 wherein the boundary is a bounding box representing physical area of a corresponding device of the plurality of devices from the device data.

8. The method as claimed in claim 7 further comprising generating, in the computer system, a boundary for the schematic layout.

9. The method as claimed in claim 1 further comprising selecting, in the computer system, a terminal direction for each of the plurality of routes.

10. The method as claimed in claim 1 wherein selecting a direction for each of the plurality of routes comprises:
checking for cross-overs, in the computer system, between each of the plurality of nodes and each of the plurality of routes; and
generating, in the computer system, at least one of a simple route, a one corner route and a two corners route.

11. A computer program product including a non-transitory computer readable medium storing instructions for causing a computer to implement an orthogonal layout generation method, the method comprising:
receiving data related to a plurality of devices for a schematic layout;
generating a node for each of the plurality of devices, hereby generating a plurality of nodes;
generating a link for each of the plurality of nodes, thereby generating a plurality of links;
orthogonalizing the plurality of nodes;
initializing a route for each of the plurality of the links, thereby generating a plurality of routes;
orthogonalizing the plurality of routes; and
selecting a direction for each of the plurality of routes.

12. The computer program product as claimed in claim 11 wherein each of the plurality of nodes can be at least one of a node for a point device, a node for an internal connectivity point and a node for an end point.

13. The computer program product as claimed in claim 11 wherein orthogonalizing the plurality of nodes reduces offsets for the plurality of routes.

14. The computer program product as claimed in claim 11 wherein the method further comprises moving nodes of the plurality of nodes that are unconnected by links to reduce at least one cross-overs and overlays between the plurality of nodes and the plurality of routes.

15. The computer program product as claimed in claim 11 wherein the method further comprises adjusting spaces between each of the plurality of nodes and other nodes of the plurality of nodes to increase the spaces above a predetermined distance.

16. The computer program product as claimed in claim 11 wherein the method further comprises generating a boundary for each of the plurality of nodes.

17. The computer program product as claimed in claim 16 wherein the boundary is a bounding box representing physical area of a corresponding device of the plurality of devices from the device data.

18. The computer program product as claimed in claim 17 wherein the method further comprises generating a boundary for the schematic layout.

19. The computer program product as claimed in claim 11 wherein the method further comprises selecting a terminal direction for each of the plurality of routes.

20. The computer program product as claimed in claim 11 wherein selecting a direction for each of the plurality of routes comprises:
checking for cross-overs between each of the plurality of nodes and each of the plurality of routes; and
generating at least one of a simple route, a one corner route and a two corners route.
